(19) United States
(12) Patent Application Publication
(10) Pub. No.: US 2003/0044243 A1
(43) Pub. Date: Mar. 6, 2003

(54) Vacuum system

(76) Inventor: Christy Tisdale, Indianapolis, IN (US)

Correspondence Address: ICE MILLER, One American Square, Box 82001, Indianapolis, IN, 46282-0002, US

(21) Appl. No.: 09/944,419

(22) Filed: Aug. 31, 2001

(51) Int. Cl. B65G 51/36

(52) U.S. Cl. 406/28

(57) ABSTRACT

An improved vacuum system comprising subsystems for exterior maintenance, interior maintenance, and mail delivery/retrieval. The system includes at least one substantially hollow conduit having first and second open ends, and an air-moving unit. The air-moving unit includes a housing having a first aperture therethrough for receipt of the first open ends of the at least one conduit(s), a second aperture therethrough, a motor capable of moving a fluid in a first direction between the first aperture and the second aperture. The first open end(s) of the at least one conduit(s) is (are) in fluidic communication with the first aperture such that the fluid moved in the first direction by the motor also moves in the first direction through the at least one conduit. The motor is able to operate as a vacuum or blower, and conduits are located inside and/or outside to permit for interior and exterior maintenance, and for mail delivery/retrieval.

### FIELD OF THE INVENTION

This invention relates to an apparatus for exterior maintenance, interior maintenance, and/or mail delivery, and, in particular to an improved vacuum system therefor.

### BACKGROUND OF THE INVENTION

There are several time-consuming, labor intensive and mundane tasks that require the attention, time and/or money of homeowners and other persons responsible for the interior and exterior maintenance of a home or other building. Among these tasks are cleaning furniture, floor surfaces and fixtures inside a home or other building, as well as gathering, moving and/or removing leaves, grass, twigs and other liquid or solid debris on one's property. In addition, the homeowner or caretaker has mail recovery and delivery responsibilities that necessitate daily trips to mailboxes and the like. Each of these tasks may require potentially extensive manual labor due to the nature of the task, the abilities of the person, physical environmental restrictions, or other factors. In addition, if several tasks are to be completed on any given day, one must expend additional effort to move among the tasks.

One task facing homeowners and building occupants is the trip to one's mail receptacle to retrieve mail that may have been delivered. There are several potential frustrations involved in performing this task. In many instances, the mail receptacle is located outside the home and is not accessible from within the climate-controlled interior of the home. Thus, to check for or deliver mail, people generally must be suitably dressed for a public appearance and may possibly have to dress for inclement weather to reach the mail receptacle. Going through all of this may prove to be in vain, for it is possible that the mail has yet to be delivered or that no mail was delivered that day. In cases where one wishes to deliver outgoing mail, it is also possible that the mail carrier has already completed his or her route. In this case, the person may want to avoid placement of the outgoing mail in the receptacle until the next mail day to avoid the possibility of theft of the mail. Mail theft contributes to the larger problem of identity theft and therefore is generally taken seriously. To automate the task of retrieval of mail, the pneumatic package or container delivery devices (“pneumatic delivery device”), such as the one disclosed by U.S. Pat. No. 4,941,777 to Kieronski, have been developed to allow mail and other items to be automatically transported through tubes between locations, such as between a mailbox and the interior of a home.

Removing dirt and dust from carpets, curtains and the like is one of the many tasks that often is performed while cleaning the inside of a home or building. Prior to the availability of electronic devices, this task often necessitated intensive manual labor, such as removing furniture cushions and hitting them against one another or beating rugs to remove dust accumulated thereon. Since that time, devices have been developed to alleviate some of the manual labor involved in such interior cleaning duties. For example, portable vacuum devices are known in the art. Generally these devices comprise an “air-moving unit,” a debris collection chamber (“chamber”), a hose, an electric motor, and an electrical cord having a plug that electrically engages a home or building outlet. Portable vacuum devices are commonly used to remove dirt and debris from interior surfaces such as bare floors, carpets, rugs, furniture, etc.

External property maintenance is another common task to which homeowners attend. Generally, external maintenance involves, among other tasks, removal of leaves, grass, sticks, water, mud and other types of liquid and solid debris from various locations. Those locations may include the yard, driveway, garage, roof, and, gutters, for example. In the past, these tasks required one to gather the debris using a broom, rake or, mop, depending on the nature and location of the debris. After gathering the debris using one of these means, one manually transported the debris to a trash can, trash bag, or other receptacle. Portable vacuum devices have been developed that are suitable for outdoor use to alleviate some of the manual labor required for outdoor tasks. These devices allow one to collect and transport debris by suction into a portable container or by merely blowing the debris to another location where it may be collected manually or by an automated means.

Although portable vacuum devices reduced some of the time and effort involved in cleaning building interiors and removing debris outside the building, such tasks are still not without shortcomings. One shortcoming is the fact that different portable vacuum devices are required for different chores. The homeowner may possess a vacuum cleaner for cleaning carpets and upholstery, a wet/dry vacuum for cleaning debris or liquid from surfaces such as cement, and a leaf blower for blowing leaves and other debris from the yard and driveway. Another shortcoming is primarily a result of the need to move portable vacuum devices between locations as one cleans a structure or grounds and the need to frequently empty the chamber upon its becoming full. Movement of the portable vacuum device or chamber can be difficult, especially when the device is moved between floors, over long distances, or when other objects must be moved to enable cleaning or debris removal.

To address these problems for interior maintenance, stationary, central vacuum devices have been developed and adapted for use inside a home or building. These stationary vacuum devices generally comprise: (1) an air-moving unit; (2) a waste receptacle; (3) several air inlets (“inlets”) disposed throughout a home or building; and (4) a plurality of conduits connecting the air-moving unit and the inlets. Central vacuum devices are well known in the art, as exemplified by U.S. Pat. No. 5,758,387 to McNamara. The user of a central vacuum device can clean multiple areas of the interior of a building on multiple floors without having to move a portable air-moving unit or frequently empty a chamber. While central vacuum systems are advantageous for cleaning the interior of a home or building, no solution has been developed for exterior maintenance to avoid the above-identified shortcomings.

Several, but not all, issues related to mail recovery or delivery, interior home and building maintenance, and exterior home and building maintenance have been addressed by the prior art. Problems continue to arise during the use of each of the devices known in the art. Exterior maintenance tasks can only be accomplished by use of several portable devices. In addition, central vacuum and pneumatic delivery devices known in the art each function separately to accomplish indoor cleaning and mail delivery tasks, respectively. A homeowner or ID property owner wishing to install a central vacuum device and a pneumatic delivery device would find that each of these devices has its own separate air-moving unit that supplies vacuum and/or blower air pressure required to accomplish their intended purpose. The air-moving unit in vacuum devices and pneumatic delivery devices generally include an electric motor. Such motors are expensive to purchase and require the provision of power to operate. Thus, special electrical and configurations may be required in support of multiple devices. Also, because central vacuum systems are generally hidden within the walls of the home or building, significant interior wall space is consumed by the many hoses required for the system. Consumption of such interior wall space may be problematic as to the structural integrity of the wall and as to the insulative characteristics of the wall. A need exists, therefore, to reduce the significant costs associated with such duplication in a device or devices required to support multiple automated tasks, such as indoor and outdoor wet/dry vacuuming and blowing, and pneumatic container delivery.

Thus, it is desired to provide a device or devices adapted to accomplish mail recovery and delivery tasks as well as indoor and outdoor wet/dry vacuuming and blower tasks. Such a device should result in the benefits currently achieved by the central vacuum devices and pneumatic delivery devices currently available in the prior art, and should also address the shortcomings associated with these prior art devices. In servicing indoor and outdoor maintenance and mail recovery and delivery, the number of devices required to be purchased and operated should be reduced. A reduction in the number of devices results in a reduction of purchase, maintenance, and repair costs required to assist in such tasks. It is also desired that duplication in conduits and other devices be reduced so as to reduce costs and to reduce the issues associated with construction constraints as discussed herein above. Of course, it is also desired that the device(s) be efficient in operation and flexible in operation, such as in allowing for different levels of blowing and/or suction to have application if or a myriad of tasks and to permit for different installation requirements. Such installation requirements may include accommodation of the various outlets of the device(s), such as the vacuum outlets within or outside the home, blower outlets outside the home, and the mail receptacle, for example.

### SUMMARY OF THE INVENTION

The present invention comprises an apparatus for use in exterior maintenance, interior maintenance, and/or mail delivery/retrieval. In one embodiment, the apparatus comprises an exterior maintenance system that includes at least one conduit. Each of the at least one conduits has a first open end and a second open end, and is substantially hollow between the ends. The second end(s) of each of the at least one conduits is (are) located outside a building. The apparatus also include an air-moving unit located inside the building. The air-moving unit includes a housing and a motor means. The housing has at least one first aperture therethrough and at least one second aperture therethrough. The motor means is positioned between the at least one first aperture and the at least one second aperture in the housing. The motor means is capable of moving a fluid in a first direction between the at least one first aperture and the at least one second aperture. The first open end(s) of the at least on conduits is (are) in fluidic communication with the at least one first aperture, such that fluid moved in the first direction by the motor means also moves in the first direction through the at least one conduit.

In one embodiment, the first direction may comprises flow from the at least one first aperture toward the at least one second aperture such that the apparatus is capable of vacuuming debris located proximate the second open end(s) of the at least one conduits through each of the at least one conduits toward a chamber positioned within the housing where the debris is collected. The first direction alternately comprises flow from the at least one second aperture toward the at least one first aperture such that the apparatus is capable of blowing debris located proximate the second open end(s) of the at least one conduits away from the respective second open end. Alternately, the motor means is reversible, i.e., capable of moving flow in both the vacuuming and blowing directions.

The exterior maintenance apparatus of the present invention addresses many of the shortcomings of prior art apparati used to perform outdoor vacuuming and blowing tasks. Presently, the homeowner is generally required to purchase a myriad of devices such as a portable shop vacuum, leaf blower, and snow blower, for example, each of which requires its own power source and which is difficult to maneuver around the exterior of a home. Consider, for example, that a shop vacuum and a leaf blower are generally not conducive to cleaning gutters or the roof of a home.

In another embodiment of the apparatus of the present invention, the apparatus includes at least one conduit located inside the building (an interior conduit). Each of the at least one interior conduits is essentially the same as the exterior conduits, having first and second open ends and being substantially hollow therebetween. The first open end(s) of the at least one interior conduits is (are) also connected to the at least one first apertures of the air-moving unit, and the second end(s) of the at least one interior conduits is (are) located within the building.

By the addition of the interior conduit(s), the apparatus of the present invention can be used to support both exterior maintenance and interior maintenance. This multi-purpose apparatus is cost effective in that only a single power source and motor are required to accomplish the vacuuming and blowing tasks within the interior of a building and exterior to the building.

In yet another embodiment of the present invention, the apparatus also includes first and second receptacles suitable for receipt of an information container. The first receptacle resides within the building interposed along one of the at least one conduits. The second receptacle is located outside the building and is connected to the second end of the one of the at least one conduits into which the first receptacle is interposed.

The addition of these receptacles allows the apparatus of the present invention to support mail delivery and retrieval. For the at least one conduit to which the first and second conduits are attached, pneumatic pressure is created by the motor means of the air moving unit to move an information container between the first and second receptacles. Of course, if the motors means is reversible, the information container may be moved between the first and second receptacles and moved between the second and first receptacles.

The use of the motor of the present invention to support a mail delivery/retrieval subsystem in addition to and interior and/or exterior maintenance subsystem results in a number of advantages for the consumer. Costs of procurement and of maintenance are reduced by use of a single system—a single motor and a single power source.

### BRIEF DESCRIPTION OF THE DRAWINGS

FIG. 1 shows a perspective and partial cut-away view of one embodiment of the apparatus of the present invention wherein the apparatus provides interior maintenance, exterior maintenance, and mail delivery/retrieval capabilities.

FIG. 2 shows a side view of one embodiment of a conduit in accordance with the present invention.

FIG. 3 shows a cross-sectional view of the conduit of FIG. 2 along the line 3-3.

FIG. 4 shows a cross-sectional view of the conduit of FIG. 2 along line 4-4.

FIG. 5 shows a schematic diagram of the air-moving unit and electronic control of one embodiment of the present invention as connected to the conduits shown in the embodiment of FIG. 1.

FIG. 6 shows a cross-sectional view of one embodiment of an exterior outlet according to the present invention.

FIG. 7 shows a perspective view of interior and exterior attachments according to one embodiment of the present invention.

FIG. 8 shows a perspective view of the interior and exterior terminals according to one embodiment of the present invention.

FIG. 9 shows a cross-sectional view along line 9-9 of the exterior terminal of FIG. 8 according to one embodiment of the present invention.

FIG. 10 shows a perspective and partial cut-away view of one embodiment of the information carrier according to the present invention.

### DETAILED DESCRIPTION OF THE INVENTION

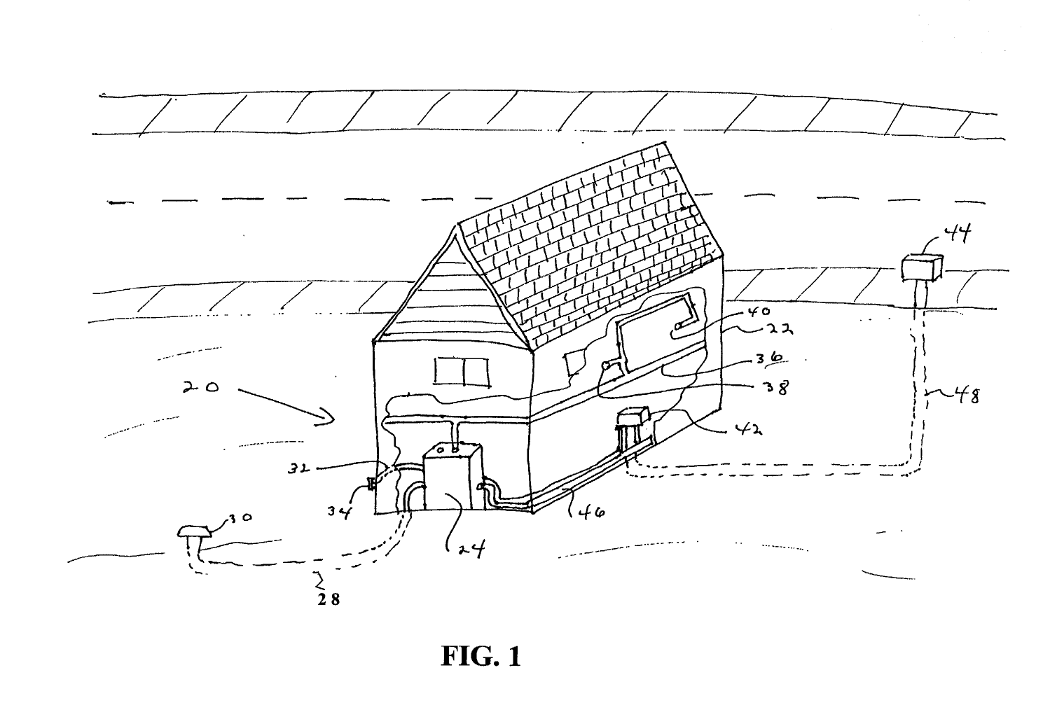

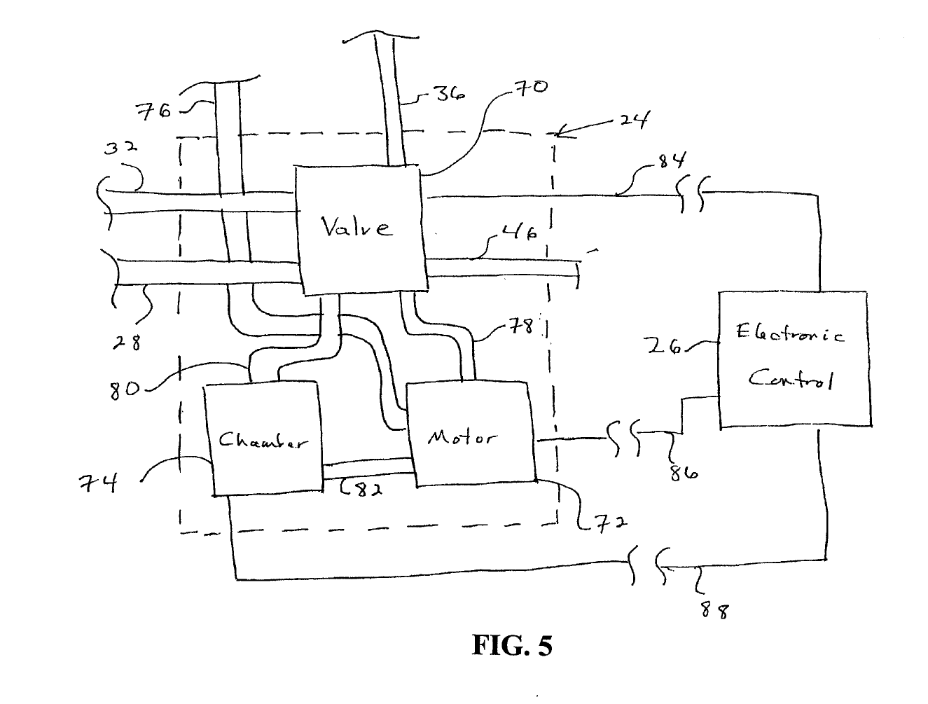

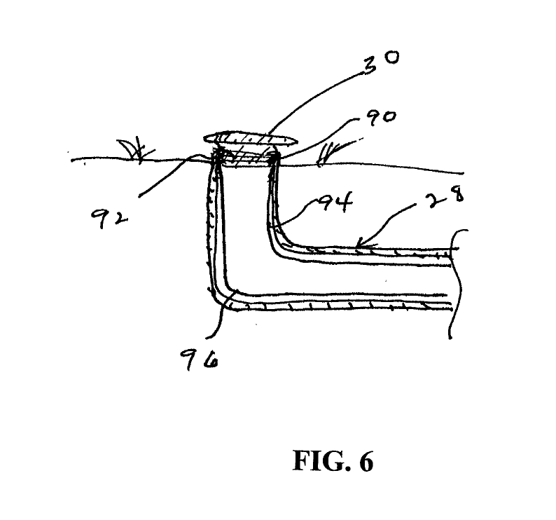

Referring now to FIG. 1, there is shown a perspective and partial cut-away view of one embodiment of the apparatus of the present invention wherein the apparatus provides exterior maintenance, interior maintenance, and mail delivery/retrieval capabilities. In this embodiment, system 20 comprises subsystems for vacuuming/blowing outside building 22, for vacuuming/blowing inside building 22, and for delivery and retrieval of mail from outside building 22. Each of these subsystems utilizes air-moving unit 24 and electronic control 26 (See FIG. 5 for more detail) for operation as is explained in greater detail herein.

In this embodiment, system 20 includes first external conduit 28 having first conduit access device 30 attached thereto, and second external conduit 32 having second conduit access device 34 attached thereto. As is explained in greater detail herein, air-moving unit 24, electronic control 26, first and second external conduits 28 and 32, and first and second conduit access devices 30 and 34 comprise one embodiment of the exterior maintenance subsystem of the present invention. The exterior maintenance subsystem of the present invention can be used to move or remove debris from the exterior of building 22.

System 20 also includes internal conduit 36 having first internal port 38 and second internal port 40 attached thereto. The combination of air-moving unit 24, electronic control 26, internal conduit 36, and first and second internal ports 38 and 40 comprise one embodiment of the interior maintenance subsystem of the present invention. The interior maintenance subsystem of the present invention can, as is explained in greater detail herein, be utilized to move or remove debris from the interior of building 22.

FIG. 1 also illustrates the major components of one embodiment of the mail delivery/retrieval subsystem of the present invention. The mail delivery/retrieval subsystem includes air-moving unit 24, control 26, first terminal 42, second terminal 44, first mail conduit 46, and second mail conduit 48, and is used for delivery and retrieval of mail from second terminal 44 located on the exterior of building 22 and first terminal 42 located proximate or interior to building 22.

Although the embodiment of system 20 shown in FIG. 1 shows a certain number of internal and external conduits, these specific numbers of conduits are not required for the present invention. Instead, system 20 is only required to have at least one conduit, and may otherwise include as few or as many as desired.

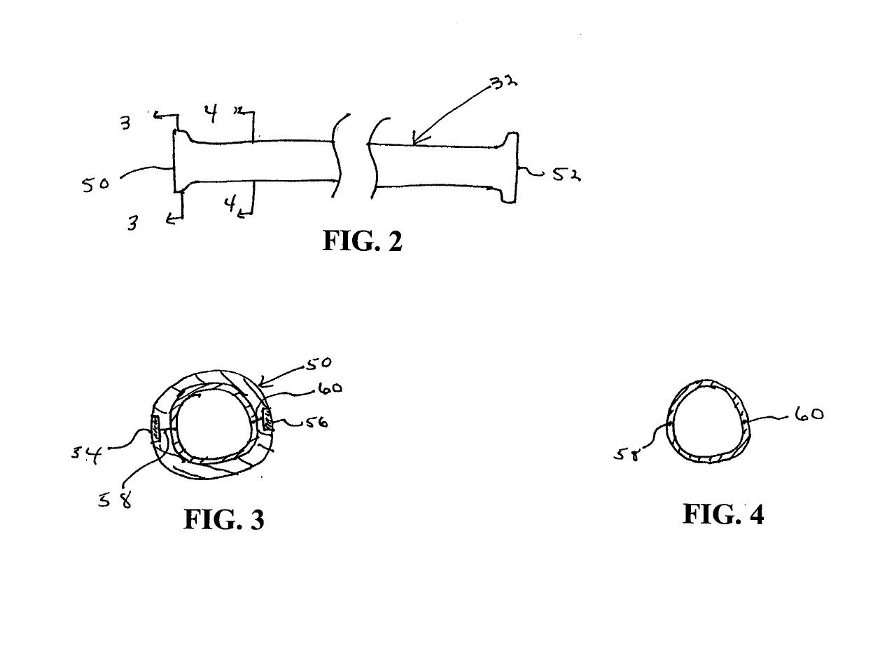

Each of conduits 28, 32, 36, 46, and 48 shown on FIG. 1 is substantially as illustrated in FIGS. 2, 3 and 4 hereof. Referring to FIG. 2, there is shown a side view of one embodiment of a conduit according to the presentation invention. Second exterior conduit 32 is substantially hollow and has first open end 50 and second open end 52. Second exterior conduit 32, in this embodiment, is comprised of cylindrical flexible material such as plastic. Alternatively, second exterior conduit 32 may comprise PVC pipe(s), vinyl, or rubber. Generally, the material of second exterior conduit 32 should be capable of carrying liquids such as water, solids such as dust, leaves, glass, twigs, etc., and a combination of liquids and solids within the hollow interior of second exterior conduit 32. As used herein and in the claims, the term “debris” refers to liquids, solids, combinations of liquids and solids, and gasses (such as air) that might be found within the conduits, in the interior of a building, or exterior to the building.

Open ends 50 and 52 are formed for connection to other parts of system 20 as is explained in greater detail herein. In the embodiment of FIG. 1, system 20 includes electronic control 26 and also includes wires for connection to electronic control 26 as is well-known in the art of interior central vacuum systems. As shown in FIG. 3, first open end 50 includes first and second electronic contacts 54 and 56, respectively. Electronically connected to first and second electric contacts 54 and 56 are first and second conductive wires 58 and 60, respectively. In this embodiment, second open end 52 is substantially the same as first open end 50, and, as is further illustrated in FIG. 4, first and second conductive wires 58 and 60 extend parallel to the longitudinal axis of second exterior conduit 32 electronically connecting first and second contacts 54 and 56, respectively, of first open end 50 to the first and second contacts (not shown) of second open end 52.

It will be appreciated by those of skill in the art that conductive wires 58 and 60 may be located inside second exterior conduit 32, outside second exterior conduit 32, or within the material that forms second exterior conduit 32 and be within the scope of the present invention. Further, electrical connection along a conduit may be achieved by wireless means, such as the combination of infrared transmitters and receivers, as is well known in the art. Such alternate electrical connections are within the scope of the present invention.

Referring now to FIG. 5, there is shown a schematic diagram of the air-moving unit and electronic control of one embodiment of the present invention as connected to the conduits shown in the embodiment of FIG. 1. Located within the housing (see FIG. 1) of air-moving unit 24 are valve apparatus 70, motor 72, and chamber 74. Connected in fluidic communication with valve apparatus 70 are first and second exterior conduits 28 and 32, interior conduit 36, and first mail conduit 46. Connected in fluidic communication with motor 72 are intake/exhaust conduit 76 and valve-to-motor conduit 78. Chamber 74 is connected in fluidic communication with valve apparatus 70 via valve-to-chamber conduit 80, and chamber 74 is connected in fluidic communication with motor 72 via chamber-to-motor conduit 82. Valve apparatus 70, motor 72, and chamber 74 are all electrically connected to electronic control 26 via valve conductor 84, motor conductor 86, and chamber conductor 88, respectively.

Valve apparatus 70 serves as a means for directing flow of air and debris within system 20. In one embodiment, each of conduits 28, 32, 36, 46, 78 and 80 comprise an open end (the first open end) engaged with (in fluidic communication with) valve apparatus 70. In this embodiment, each of the first open ends of conduits 28, 32, 36, 46, 78 and 80 are seemingly opened and closed by valve apparatus in response to electric signals from electronic control 26, as is known in the art. Further, valve apparatus 70 is operated to selectively open and close two or more of conduits 28, 32, 36, 48, 78, and/or 80 to permit the contents of each conduit to flow through valve apparatus 70 from a first such conduit to a second such conduit.

In one embodiment, valve apparatus 70 comprises a plurality of solenoid-operated valves which open in the presence of electrical current, and close in the absence of an electrical current, which such electrical current switched by electronic control 26. Other valve and switching mechanisms known in the art are contemplated to be within the scope of the invention.

In the embodiment of FIG. 5, motor 72 comprises a reversible motor capable of moving the contents of conduits 28, 32, 36, and 46 in a first direction away from valve apparatus 70 toward motor 72 for the purpose of vacuuming the contents of the exterior maintenance subsystem, the interior maintenance subsystem, and the mail delivery/retrieval subsystem of the present invention. Motor 72 is also capable of moving the contents in a second direction from intake/exhaust conduit 76 into valve-to-motor conduit 78 for the purpose of blowing air through the exterior maintenance subsystem, the interior maintenance subsystem, and/or the mail delivery/retrieval subsystem of the present invention.

Electronic communication between electronic control 26 and valve apparatus 70, motor 72, and chamber 74 takes place in this embodiment via valve conductor 84, motor conductor 86, and chamber conductor 88, respectively, and in this embodiment comprises two-way communication. Specifically, electronic control 26 is able to accept signals from and send signals to valve apparatus70, motor 72 and chamber 74, by means well known in the art of electronics, interior central vacuum systems, and mail delivery systems. The interplay of electronic control 26 and air-moving unit 24 is discussed in greater detail hereinafter in connection with the discussion of the operation of system 20.

Referring now to FIG. 6, there is shown a cross-sectional view of the embodiment of an exterior outlet according to the present invention. Specifically, first exterior conduit 28 is threadably engaged with first conduit access device 30. First exterior conduit 28 includes first and second electrical contacts 90 and 92, respectively, having first and second conductors 94 and 96, respectively, electrically connected thereto. The other ends of first and second conductors 94 and 96 are electrically connected to electronic control 26. Other means, well-known in the art of interior central vacuum systems may be used to engage first conduit access device 30 with first exterior conduit 28, and such means are contemplated to be within the scope of the present invention. Generally, however, first conduit access device 30 should be flush with the ground or slightly raised to permit lawn mowing without damage to device 30.

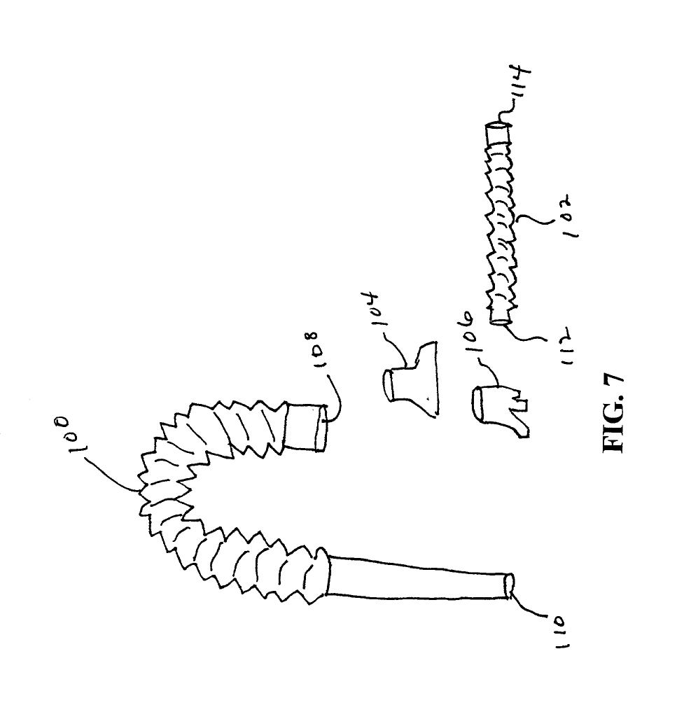

FIG. 7 shows a perspective view of interior and exterior attachments according to one embodiment of the present invention. Specifically, FIG. 7 shows one embodiment of hose 100, extension hose 102, nozzle 104, and rake 206. Hose 100 includes first and second open ends 108 and 110, respectively, and has a substantially hollow interior there between. Extension hose 102 comprises first and second open ends 112 and 114, respectively. First end 108 of hose 100 and first end 112 of extension hose 102 are formed to sealingly engage with an access port, such as first exterior access device 30 illustrated in FIG. 6. First end 108 of hose 100 and first end 112 of extension hose 102 each have a conductor in the exterior thereof (not shown) sized and positioned for contact with the electrical contacts of the first open end of the conduit, such as first and second contacts 90 and 92, respectively, of first exterior conduit 28 as shown in FIG. 6 such that electricity may flow through the circuit comprising the first conductor of the conduit, the first electrical contact of the conduit, the conductor of hose 100 (or the conductor of extension hose 102), the second contact of the conduit, and the second conductor of the conduit.

In the event extension hose 102 is connected to an access port, first end 108 of hose 100 is connected to second end 114 of extension hose 102. Nozzle 104 and rake 106 are vacuum devices and are representative of those known in the art and are for sealed engagement with second end 110 of hose 100.

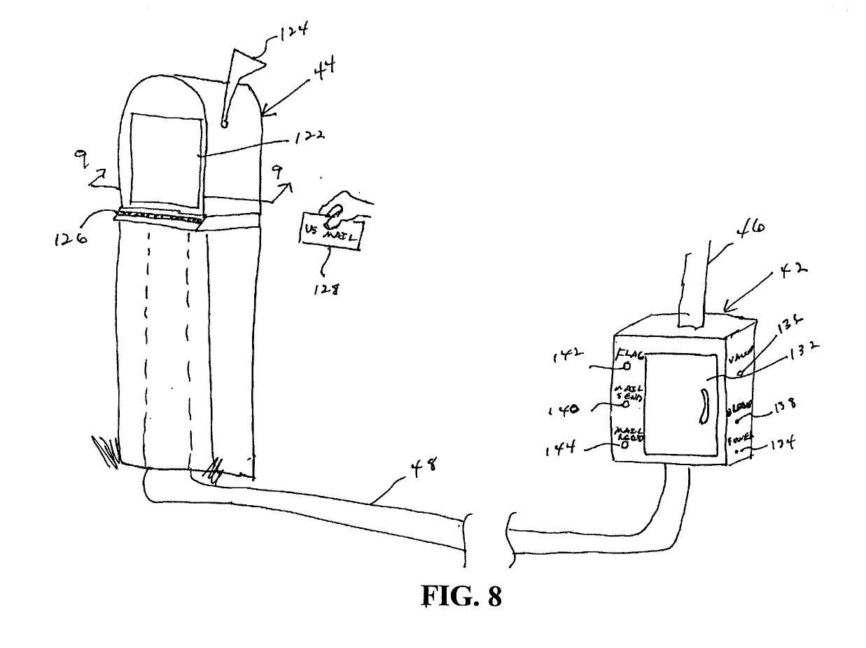

Referring now to FIG. 8, there is shown a representative view of the interior and exterior terminals according to one embodiment of the present invention. First terminal 42 is in fluidic communication with air-moving unit 24 via first mail conduit 46 and is in fluidic communication with second terminal 44 via second mail conduit 48. Generally, first terminal 42 is located inside building 22. Generally, second terminal 44 is located exterior to building 22 as required for location of the mailbox of the residents of building 22.

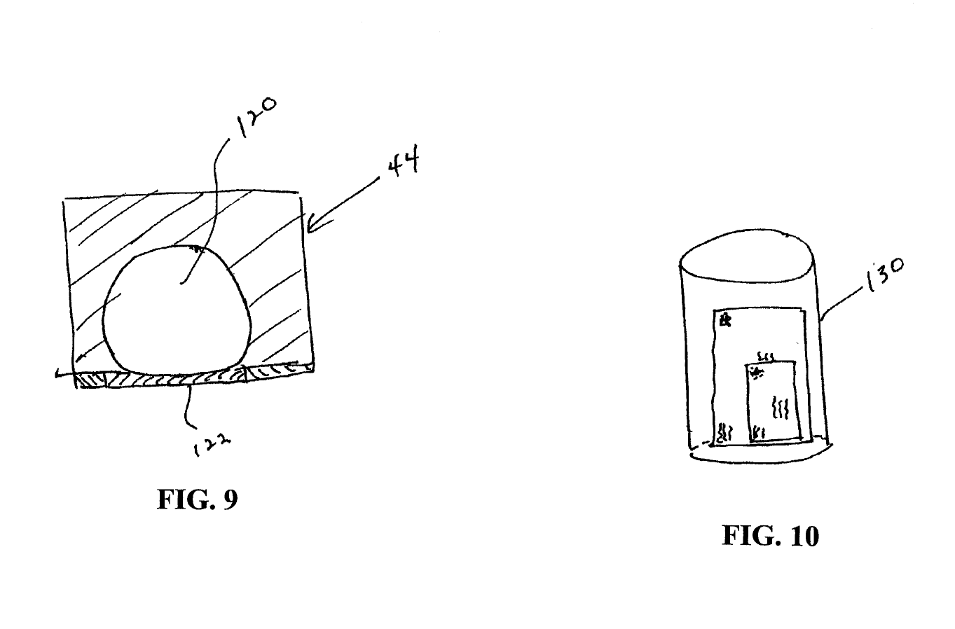

Both first terminal 42 and second terminal 44 comprise interior compartment 120 (See FIG. 9 showing a top cross-sectional view of second terminal 44) suitable for receipt of information carrier 130 (See FIG. 10) as is explained in greater detail herein. In the embodiment of FIG. 8, second terminal 44 comprises electronically activated door 122, electrically activated flag 124, and magnetic card receiver 126. Card receiver 126 is capable of reading card 128 for entry to compartment 120 through door 122 of second terminal 44 and is optional. Second terminal 44 may comprise a key for access to compartment 120, or other security mechanism well known in the art. Also, second terminal 44 may comprise no security mechanism, although to assist in addressing the problem of mail theft, a security mechanism may be desired. FIG. 9 and FIG. 10 illustrate that information carrier 130 is sized for receipt of mail (letters, magazines, postcards, small packages, and the like). Compartment 120 is sized for receipt of information carrier 130 with little or substantially no air space surrounding information carrier 130 when placed in compartment 120.

First terminal 42 comprises an internal compartment accessed through door 132. The internal compartment of first terminal 42 (not shown) is substantially the same as internal compartment 120 of second terminal 44. Second mail conduit 48 surrounds the exterior of information carrier 130 such that little or substantially no space exists between the outer surface(s) of information carrier 130 and the interior surface(s) of second mail conduit 48. Because information carrier 130 does not pass through first mail conduit 46, there are no size restrictions imposed based on information carrier 130 for first mail conduit 46.

In the embodiment of FIG. 8, electronic control 26 resides within first terminal 42. Hence, first terminal 42 includes first selector 134 for providing electric power to electronic control 26, vacuum selector 136 for setting electronic control 26 in vacuum mode, blower selector 138 for setting electronic control 26, mail send selector 140 for instructing first terminal 42 to send information carrier 130 from first terminal 42 to second terminal 44, flag indicator 142 indicating that information carrier 130 has been sent to second terminal 44, and mail received indicator 144 to indicate that information carrier 130 has been sent to first terminal 42.

As previously mentioned, first mail terminal 42 includes electronic control 26 and a compartment for holding information carrier 130 for sending and retrieving mail by an occupant. Thus, it is generally desirable that first mail terminal 42 be located in an interior location considered convenient by the occupant(s) of building 22. It is not required, however, for all the electronic control features to be located in or beside first terminal 42, however, and therefore, multiple locations of the functionality of electronic control 26 are possible and considered to be within the scope of the present invention. Electronic control 26 may comprise a computer of a type well known in the art of control systems configured and programmed to carry out the functions delegated to electronic control 26 according to the present invention. Further, some or all of the functions of electronic control 26 may be activated remotely by means well known in the art of electronics so that one or all of the selectors and indicators illustrated in FIG. 8 are remotely accessed. To accommodate such remote access, electronic control 26 must comprise transmitters and receivers using infrared or other wireless means well known in the art for communicating between a remote device and electronics connected directly to system 20. The remote device(s) of such an alternative may be separate from or connected to a part of system 20. For example, a remote selector of vacuuming or blowing functions may be placed at the access device to which the hose is connected. While these alternatives are within the scope of the present invention, the operation of system 20 is discussed in view of the embodiment shown in FIGS. 1-10.

Both first and second terminals 42 and 44 are constructed in accordance with prior art pneumatic receptacles for transference of a container. First terminal 42 is interposed along an exterior conduit comprising first and second mail conduits 46 and 48. First mail terminal 42 comprises an intake port and an exhaust port for connection to this exterior conduit. In the embodiment of FIG. 8, the second open end of first mail conduit 46 is in fluidic communication with the intake port of the first terminal 42 and the first open end of second mail conduit 48 is in fluidic communication with the exhaust port of first terminal 42. In this manner, the contents of the exterior conduit can be moved through first terminal 42. First terminal 42 also includes a sealable opening to the compartment of first terminal 42 through which an information container may be inserted into first terminal 42. This sealable opening is movable between an open position allowing an information container to enter or exit the compartment of first terminal 42 from second mail conduit 48 and a closed position in which an information container is held in the compartment of first terminal 44.

Similarly, second terminal 44 comprises an intake port in fluidic communication with the second open end of second mail conduit 48 (the second open end of the exterior conduit). Second terminal 44 also includes a sealable opening through which an information carrier may be inserted into second terminal 44 is moveable between an open position allowing an information container to enter or exit compartment 120 of second terminal 44 from second mail conduit 48 and a closed position in which an information container is held in compartment 120 of second terminal 44.

Whether operating system 20 for exterior maintenance, interior maintenance, or mail delivery/retrieval, power must be provided to system 20 for operation. In the embodiment of FIG. 8, the occupant is able to turn on and off electrical power to system 20 via power selector 134 located on first mail terminal 42.

Consider, first, the operation of system 20 for vacuuming debris located exterior to building 22. To perform such an exterior vacuuming function, the occupant turns on power to system 20 via power selector 134 and selects vacuum selector 136. By selecting vacuum selector 136, system 20 is set up in vacuum mode for both exterior and interior maintenance. The occupant then removes the access port (device) of an exterior conduit, such as first access port device 30 of first exterior conduit 28 (see FIG. 6) and connects a hose, such as hose 100 or extension hose 102 (See FIG. 7) to the first open end of the exterior conduit. The connection of the hose results in creation of a closed electrical circuit to consequently engage motor 72 to move in the first direction as described hereinabove. By way of example, connection of hose 100 to the first open end of first exterior conduit 28 results in a closed electric circuit from electronic control 26 including first conductor 96 of first exterior conduit 28, first contact 90 of first exterior conduit 28, the conductor (not shown) of first end 108 of hose 100, second contact 92 of first exterior conduit 28, and second conductor 96 of first exterior conduit 28. Detection by electronic control 26 of this closed circuit causes motor 72 to move in the first direction and sets valve apparatus 70 as is described below for the exterior vacuuming mode of system 20 through first exterior conduit 28.

Setting electronic control 26 in external vacuuming mode through first exterior conduit 28 causes the following to occur. First, valve apparatus 70 is set to open for first exterior conduit 28, to open for valve-to-motor conduit 78, and to open for valve-to-chamber conduit 80. All other conduits connected to valve apparatus 70, namely conduits 32, 36, and 46, are closed. Motor 72 is activated to draw air from valve-to-motor conduit 78 which subsequently causes the contents of first exterior conduit 28 to be drawn from second end 110 of hose 100 through hose 100 and through first exterior conduit 28 to valve apparatus 70. The contents entering valve apparatus 70 through first external conduit 28 are directed through valve-to-chamber conduit 80 into chamber 74. Chamber 74 includes a filter means (not shown) of the type well-known in the art of wet/dry vacuums, to allow any air, but no other debris, to flow through chamber-to-motor conduit 82 toward motor 72. Air drawn into motor 72 through the chamber-to-motor conduit 82 is exhausted through intake/exhaust conduit 76. In this manner, debris and liquid located proximate second end 110 of hose 100 (or an attachment connected to second end 110 of hose 100) are drawn into and collected in chamber 74.

Operation of system 20 in the vacuuming mode for first exterior conduit 28 may be ceased in three ways. First, the occupant may turn off power by use of power selector 134 of first mail terminal 42. Second, the occupant may disconnect hose 100 (or extension hose 102, if used) from the first open end of first exterior conduit 28, which has the affect of breaking the electrical circuit described above. Third, if chamber 74 becomes full, a sensor (not shown) located in chamber 74 sends a signal via chamber conductor 88 to control 26. Receipt by control 26 of the chamber full signal results in a shut off of electric power by control 26.

Turning now to operation of system 20 to blow debris located exterior to building 22, the power to system 20 must be turned on as previously described herein. At first terminal 42, the occupant selects the blower mode by blower selector 138 (See FIG. 8). The occupant must connect hose 100 or extension hose 102 to an external access port (such as first exterior access device 30), such by removal of first access port device 30 as described herein. Upon electrical connection of hose 100 or extension hose 102 to the first open end of an external conduit, such as first exterior conduit 28 shown in FIG. 6, a closed electronic circuit is formed as described hereinabove. Electronic control 26 recognizes the closed circuit and the fact that blower selector 138 has been selected to place system 20 in external blowing mode through the exterior conduit to which hose 100 or extension hose 102 is attached.

Setting electronic control 26 in external blowing mode for first exterior conduit 28 causes the following to occur. First, valve apparatus 70 is set to open for first external conduit 28 and to open for valve-to-motor conduit 78. All other conduits, namely conduits 32, 36, 46, and 80 connected to valve apparatus 70 are set to the closed position. Motor 72 is activated to the second direction whereby air enters motor 72 through open intake/exhaust conduit 76 and is blown through value-to-motor conduit 78 into valve apparatus 70 and subsequently into first exterior conduit 28. The movement of air through first external conduit 28 causes debris located near second end 110 of hose 100 (or through an attachment connected to second end 110 of hose 100) to be blown away from the second end 100 of hose 100 (or through an attachment connected to second end 100 of hose 100).

It will be appreciated by those of skill in the art that the exterior maintenance subsystem provides several advantages across the prior art. First, most outdoor tasks, such as leaf removal, gutter cleaning, snow blowing, exterior wall cleaning, and the like, are generally achieved today by the use of several portable devices, such as a shop vacuum and a leaf blower. Further, the occupant must have exterior power outlets and must use long extension cords to connect to the devices. The power connection and cords are cumbersome and awkward. The power plug or extension cords may become disconnected resulting in loss of power. When moving about the exterior of the building, the portable devices must be transported (carried a rolled). The occupant may have to make several unnecessary “trips” about the exterior, such as when moving the cord about bushes and other obstructions, or connecting the cords to different outlet, or emptying the debris chamber of a portable device. If any of the devices are powered by gasoline, the issues related to cords may not exist, but the occupant may need to make trips to refill the device with gasoline or oil, must usually use force to start the device (such as by pulling a rope), must carry the added weight of the gasoline in the device, and must deal with the messy, dangerous gasoline power source.

The exterior maintenance system of the present invention addresses each of these shortcomings. Use of electrical power eliminates the shortcomings arising from gasoline-powered devices. The placement of exterior access ports throughout the exterior of the building eliminates the requirement to carry portable devices. Instead, the occupant only needs to transport the base and/or attachments desired to be used from access port to access port. The occupant does not need to carry the debris gathered for it is collected at the air-moving unit rather than at the device itself. Further, a plurality at tasks can be accomplished with the exterior maintenance subsystem. For example, when used in the vacuuming mode for exterior conduits, the subsystem can be used to clean exterior surfaces, clean gutters of debris, clean driveways and sidewalks, clean the garage, clean the unit, and even clean the family automobile parked outside the home. When used in the blowing mode for exterior conduits, the subsystem can be used to blow leaves, snow, and other debris. The subsystem is able to vacuum and blow various types of debris and liquids as are often found on the exterior of a building. Air-moving unit 24 is capable of handling liquids, liquids mixed with solids, and solids.

Considering now the operation of the interior maintenance subsystem of the present invention, the occupant selects power and either the vacuum or blower modes as is previously described herein in connection with the exterior maintenance subsystem. Similarly, the occupant may connect hose 100 or extension hose 102, with or without attachments, to any of the internal access ports. Motor 72, valve apparatus 70, and chamber 74 operate in much the same manner as described above, except that valve 70 operates to provide access to the interior conduit, such as interior conduit 36 shown in FIG. 1, to which a hose 100 or extension hose 102 has been connected.

It will be appreciated by those of skill in the art that the combination of interior maintenance subsystem and exterior maintenance subsystem provides several advantages over the prior art. A single air-moving unit is used to support both types of tasks, resulting in lower costs for improvement of the subsystem and lower maintenance costs. A single debris collection chamber is used to support interior and exterior vacuuming tasks. A single set of hoses, exterior hoses, and attachments are all that is required for so many varied tasks performed inside and outside the building.

Considering now the operation of the mail delivery/retrieval subsystem of the present invention, power must be supplied to system 20 as by selection of power selector 134 of first mail terminal 42 (See FIG. 8). To send mail from first mail terminal 42 to second mail terminal 44 for pickup by a postal carrier, the occupant places the items to be mailed into 115 information container 130 (See FIG. 10). The occupant opens door 132 of first terminal 42 and places information container 130 in the compartment inside first mail terminal 42 and closes door 132. The occupant then selects mail send selector 140. Selection of mail send selector 140 sets electronic control 26 in mail delivery mode.

When set in mail delivery mode, electronic control 26 sets valve apparatus 70 such that first mail conduit 46 and valve-to-motor conduit 78 are open, and all other conduits, namely, conduits 28, 32, 36, and 80 are closed. Motor 72 is set to run in the second (blower direction) to force air from intake conduit 76 through valve-to-motor conduit 78 and value apparatus 70 into first mail conduit 46. The blowing of air into first mail conduit causes release of information carrier 130 from first mail terminal 42 through second mail conduit 48 into second mail terminal 44. When information carrier 130 reaches its position within second mail terminal 44, electronic control 26 cause motor 72 to stop, flag 124 to raise, and flag indicator 142 to indicate that mail exists in second mail terminal 44 for pickup by a postal carrier.

For a postal carrier to either retrieve mail in second mail terminal 44 as indicated by raised flag 124 and/or to place mail in second mail terminal 44, the postal carrier swipes card 128 through magnetic card reader 126. Assuming that card 128 has a code acceptable for entry, as determined by electronic control 26, electronic control 26 checks to see whether information carrier 130 resides within second mail terminal 44. If information carrier is not within second mail terminal 44, electronic control 26 causes valve apparatus 70 to close all conduits except first mail conduit 46 and valve-to-motor conduit 78, and causes motor 72 to move in the second direction to force air input from intake/exhaust conduit 76 through valve apparatus 70 and through first mail conduit 46 to move information carrier 130 from inside first mail terminal 42 through second mail conduit 48 to second mail terminal 44, such as is done when the occupant sends mail from first mail conduit 42 to second mail conduit 44 as is described hereinabove. Further, if information carrier 130 needed to be so moved to second mail terminal 44, electronic control 26 then causes motor 72 to shut off and valve apparatus 70 to close all conduits.

With information carrier now residing within compartment 120 of second mail terminal 44 and an appropriate code read by card reader 126, electronic control 26 causes door 122 of second mail terminal to open thereby exposing information carrier 130 to the postal carrier. The postal carrier removes information carrier 130 and places any mail items in information carrier 130. The postal carrier then places information carrier 130 back into compartment 120 of second mail terminal 44. Electronic control 26 then closes door 122 of second mail terminal 44 and, if flag 124 had been raised, returns flag 124 to the lowered position, causing flag indicator 142 to indicate that flag 124 is no longer raised.

Two options exist for sending information carrier 130 back to first mail terminal 42 from second mail terminal 44. Specifically, the process of so sending information carrier 130 may be invoked upon selection of mail received selector 144, or automatically upon detection by electronic control 26 that information carrier 130 has been returned to compartment 120 after removal thereof, such as by the postal carrier.

Regardless of how invoked, the process of sending information carrier 130 from second mail terminal 44 to first mail terminal 42 begins by electronic control 26 closing all conduits connected to valve apparatus 70 except for first mail conduit 46 and valve-to-motor conduit 78. Motor 72 is then activated to run in the first (vacuuming) direction whereby motor 72 draws air from within first mail conduit 46 through valve apparatus 70 and into intake/exhaust conduit 76 (which, in this instance, serves as an exhaust conduit). Alternately, air could be drawn into valve-to-chamber conduit 80 as is done in the vacuuming modes for interior and exterior vacuuming.

The air pulled (vacuumed) from first mail conduit 46 goes through first mail terminal 42 and through second mail conduit 44. Thus, information carrier 130 residing in second mail terminal 44 is pneumatically moved (vacuumed) from second mail terminal 44 through second mail conduit 48. When electronic control 26 determines that information carrier 130 resides within the compartment (not shown) of first mail terminal 42, electronic control 26 causes motor 70 to shut off and valve apparatus 70 to close all conduits.

It will be appreciated by those of skill in the art that the inclusion of the mail delivery/retrieval subsystem to system 20 provides the occupant with additional conveniences. The occupant is not required to go outside the building to retrieve the mail, will know whether or not mail has been received, and will know whether or not the postal carrier has picked up mail. These and other conveniences are realized without significant additional expenditure, for the same air-moving unit is used for pneumatic delivery and retrieval of the mail as is used for interior and/or exterior maintenance.

It will be further appreciated that the multi-functional system of the present invention introduces numerous cost savings when compared to prior art interior maintenance subsystems, exterior maintenance subsystems, and mail delivery/retrieval subsystems. A single power source is all that is required to achieve the many functions. Only one air-moving device is necessary to support vacuuming, blowing, and pneumatic functions. Thus, purchase, delivery and installation, and repair and maintenance costs are significantly reduced when compared to a plurality of separate devices or systems.

It will also be appreciated that the system of the present invention need not interfere with the aesthetic characteristics of the exterior or interior of the building. The conduits are generally hidden within the walls of the building, in basements or garages, or underground. Air-moving unit 24 is likely installed in a basement, attic, garage, or shed located proximate the building. Both exterior and interior access ports may be made to be visible, yet blend with their surroundings. Also, first and second mail terminals 42 and 44 can also be made to be aesthetically pleasing.

It will be still further appreciated that system 20 can be configured in a myriad of ways. Prior to installation, it is likely that the occupant would decide where to locate first and second mail terminals 42 and 44, and would decide the location and number access ports for exterior and interior conduits.

It will be yet further appreciated that motor 72 may, in addition to being able to operate in both a first and second direction, be variable in speed. Such variations in speed may be automatically set by electronic control 26 and/or controlled by selection by the occupant. Such speed variation may be helpful to accommodate varying lengths of conduits. For example, a higher speed may be required for a longer conduit, such as an external conduit having an access port located 100 feet from air-moving unit 24 when compared to an internal conduit having an access port located 20 feet from air-moving unit 24. Also, greater speed may be necessary for vacuuming than for blowing, or for mail delivery/retrieval than for blowing and/or vacuuming, for example.

It will also be appreciated that the motor means of the air-moving unit of the present invention may comprise more than one motor and be within the scope of the invention. For example, a plurality of motors may be utilized cooperatively to provide increased vacuuming or blowing power for a long conduit (such as a conduit located external to the building/or to move an information carrier capable of holding a significant weight of mail objects. Alternatively, one motor could support vacuuming through one conduit while another motor supports blowing through another conduit, or one motor could be used to support the mail delivery/retrieval subsystem while another is used to support interior and exterior maintenance.

It will be still further appreciated that the orientation of subsystems of the present invention are not mutually exclusive. Thus, multiple motors may be required or desired.

It will also be appreciated that a conduit may comprise a first open end for connection to air-moving unit 24 and more than one-second open ends for access ports to that conduit. Internal conduit 36 of FIG. 1 illustrates a multiple access port interior conduit.

It will be further appreciated that system 20 may comprise any one or more of the interior maintenance subsystem, exterior maintenance subsystem, and mail delivery/retrieval subsystem and still be within the scope of the present invention. For example, an existing building may be retrofitted with a system comprising exterior maintenance subsystem and mail delivery/retrieval subsystem. Generally, a system consisting of at least the exterior maintenance subsystem, with or without any additional subsystem, is contemplated to be within the scope of the invention.

It will be still further appreciated that various electronic sensors and control devices currently used in the separate devices used today for a central vacuum, portable vacuum, portable blower, and/or mail delivery/retrieval pneumatic system may be used with the electronics of system 20.

It will be yet further appreciated that various schema can be employed for control of the subsystems of the system and be within the scope of the invention. Criteria can be determined and programmed in the electronic control to prevent or prohibit multiple operations through one or more conduits of the system. For example, if a single motor is used in the air-moving unit, the control may prohibit any other operation of a single conduit in operation. If a single conduit is in vacuum mode, the control may permit vacuuming through another conduit or retrieval of mail from the outside terminal. Hierarchies of operation could also be established. For example, if the postal carrier causes the door on the outside terminal to be opened, any other function engaged by the system may be disabled until the information carrier is moved (if necessary) to the outside terminal. Of course, these and many other options of operation are feasible so as to accommodate the desires of the manufacturer, installer, and/or user of the system.

As used herein and in the claims, the term aperture refers to an opening formed for the purpose of allowing two components to be in fluidic communication with each other. Fluidic communication refers to the passage of a liquid and/or air (gasses) with or without solids in particles or pieces contained in the liquid and/or air (gasses).

I claim:

1. An apparatus, comprising:
at least one conduit, each of the at least one conduits having a first open end and a second open end and being substantially hollow therebetween, the second ends of each of the at least one conduits located outside a building; and
an air-moving unit located inside the building, the air-moving unit including
a housing having at least one first aperture therethrough and having at least one second aperture therethrough, and
motor means within the housing and positioned between the at least one first aperture and the at least one second aperture, the motor means capably of moving a fluid in a first direction between the at least one first aperture and the at least one second aperture,
the first open ends of each of the at least one conduits in fluidic communication with the at least one first aperture such that the fluid moved in the first direction by the motor means also moves fluid in the first direction through the at least one conduit.

2. The apparatus of claims 1, further comprising:
wherein the first direction flows from the at least one first aperture toward the at least one second aperture such that the apparatus is capable of vacuuming debris located proximate the second open ends of the at least one conduits through each of the at least one conduits toward the chamber.
a chamber within the housing,

3. The apparatus of claim 1, wherein the first direction flows from the at least one second aperture toward the at least one first aperture such that the apparatus is capable of blowing debris located proximate the second open ends of the at least one conduits away from the respective second open end.

4. The apparatus of claim 2, wherein the motor means is also capable of moving the fluid in a second direction between the at least one first aperture and the at least one second aperture, the second direction flowing from the at least one second aperture toward the at least one first aperture such that the apparatus is capable of blowing debris located proximate the second open ends of the at least one conduits away from the respective second open end, the motor means further comprising a switch having a first position and a second position, such that when the switch is in the first position, the motor means causes the fluid to flow in the first direction and when the switch is in the second position, the motor causes the fluid to flow in the second direction.

5. The apparatus of claim 1, wherein the fluid comprises air.

6. The apparatus of claim 1, wherein the debris comprises at least one liquid.

7. The apparatus of claim 1, wherein the debris comprises at least one solid.

8. The apparatus of claim 1, further comprising:
a control device operatively connected to the motor means.

9. The apparatus of claim 8, further comprising:
a chemical within the housing, and
an indicator operatively connected to the chamber and to the control device, the indicator providing an indication of whether the chamber is full of debris.

10. The apparatus of claim 1, further comprising:
a first receptacle suitable for receipt of an information container, the first receptacle residing within the building interposed along one of the at least one conduits and comprising an intake port, an exhaust port, and a sealable opening through which the information container may be inserted into the first receptacle, the intake port and exhaust port of the first receptacle in fluidic communication with the at last one conduit; and
a second receptacle suitable for receipt of the information container, the second receptacle having an intake port and a sealable opening through which the information container may be inserted into the second receptacle, the intake port of the second receptacle in fluidic communication with the second end of one of the at least one conduits,
such that movement of the fluid in the first direction between at least one first aperture toward the at least one second aperture causes movement of the information container between the first and second receptacles.

11. The apparatus of claim 1, further comprising:
at least one internal conduit, each of the at least one internal conduits having a first open end and a second open end and being substantially hollow therebetween, the first open end of each of the at least one internal conduit in fluid communication with the at least one first aperture and the second open ends of each of the of at least one internal conduits located inside the building,
such that fluid moved in the first direction by the motor means also moves fluid in he first direction through the at least one internal conduit.

12. The apparatus of claim 1, further comprising:
an electronic control electrically connected to the motor means, the electronic control controlling the provision of electrical power to the motor means such that when the electronic control provides electrical power to the motor means, the motor means engages to move fluid in the first direction.

13. The apparatus of claim 1, wherein the motor means is also capable of moving fluid in a second direction between the at least one first aperture and the at least one second aperture, the second direction flowing from the at least one second aperture toward and the at least one first aperture such that the apparatus is capable of blowing debris located proximate the second open ends of the at least one conduits away from the respective second open end, the motor means having a switch having a first position and a second position and electrically connected to the electronic control means, the electronic control capable of activating the switch to the first position to cause the fluid to flow in the first direction and of activating the switch to the second position to cause the third to flow in the second position.

14. The apparatus of claim 12, wherein the electronic control is connected to the motor means by at least one wire.

15. The apparatus of claim 12, wherein the electronic control is connected to the motor means by wireless means.

16. An apparatus, comprising:
at least one external conduit, each of the at least one external conduits having a first open end and a second open end and being substantially hollow therebetween, the second ends of each of the at least one external conduits located outside a building;
at least one internal conduit, each of the at least one internal conduits having a first open end and a second open end and being substantially hollow therebetween, the second ends of each of the at least one internal conduits located inside the building; and
an air-moving unit located inside the building, the air-moving unit including
a housing having at least one first aperture therethrough and having at least one second aperture therethrough, and
motor means within the housing and positioned between the at least one first aperture and the at least one second aperture, the motor means capable of moving a fluid in a first direction between the at least one first aperture and the at least one second aperture,
the first open ends of each of the at least one external conduits and each of the at least one internal conduits in fluidic communication with the at least one first aperture such that the fluid moved in the first direction by the motor means also moves in the first direction through the at least one external conduits and the at least one internal conduits.

17. The apparatus of claim 16, further comprising:
a first receptacle for receipt of an information container, the first receptacle residing within the building interposed along one of the at least one external conduits, and comprising an intake port, an exhaust port, and a sealable opening through which the information container may be inserted into the first receptacle, the intake port and exhaust port of the first receptacle in fluidic communication with the at least one external conduit to which the first receptacle is interposed; and
a second receptacle suitable for receipt of the information carrier, the second receptacle having an intake port and a sealable opening through which the information carrier may be inserted into the second receptacle, the intake port of the second receptacle in fluidic communication with the second end of the at least one external conduits to which the first receptacle is interposed,
such that movement of the fluid in the first direction between the at least one first aperture and the at least one second aperture causes movement of the information container between the first and second receptacle.

18. An apparatus, comprising:
at least one external conduit, each of the at least one external conduits having a first open end and a second open end and being substantially hollow therebetween, the second ends of each of the at least one external conduits located outside a building;
at least one internal conduit, each of the at least one internal conduits having a first open end and a second open end and being substantially hollow therebetween, the second ends of each of the at least one internal conduits located inside the building;
a first receptacle suitable for receipt of an information container located within the building, the first receptacle having an intake port, an exhaust port, and a sealable opening through which the information container may be inserted into the first receptacle;
a second receptacle suitable for receipt of the information container located outside the building, the second receptacle having an intake port and a sealable opening through which the information container may be inserted into the second receptacle;
first and second delivery conduits, each of the first and second delivery conduits having a first open end and a second open end, the first open end of the first delivery conduit in fluidic communication with the at least one first apertures, the second open end of the first delivery conduit in fluidic communication with the intake port of the first receptacle, the first open end of the second delivery conduit in fluidic communication with the exhaust port of the first receptacle, and the second open end of the second delivery conduit in fluidic communication with the intake port of the second receptacle; and
an air-moving unit located inside the building, the air-moving unit including
a housing having at least one first aperture therethrough and having at least one second aperture therethrough,
motor means within the housing and positioned between the at least one first aperture and the at least one second aperture, the motor means capably of moving a fluid in a first direction flowing from the at least one first aperture toward the at least one second aperture and in a second direction flowing from the at least one second aperture toward the at least one first aperture,
a switch operatively connected to the motor means and operable between a first and second position, such that when the switch is in the first position the motor means causes the fluid to flow in the first direction and when the switch is in the second position the motor means causes the fluid to flow in the second direction and
a chamber within the housing and positioned between the motor and the at least one first aperture,
the first open ends of each of the at least one external conduits, the first open end of each of the at least one internal conduits, and the first open end of delivery conduit in fluidic communication with the at least one first aperture such that the fluid moved in the first direction by the motor means is capable of moving fluid in the first direction through at least one of the group consisting of the at least one external conduits, the at least one internal conduits, and the delivery conduit.

19. The apparatus of claim 18, further comprising:
an electronic control electrically connected to the switch of the motor means for controlling the provision of electrical power to the motor means and for activating the switch to either the first position or the second position.

20. The apparatus of claim 19, wherein the electronic control is further capable of controlling the level of electrical power provided to motor means.

21. The apparatus of claim 18, further comprising:
a first circuit electrically connected to the at least one external conduit and to the electronic control; and
a second circuit electrically connected to the at least one internal conduit and to the electronic control,
the electronic control capable of detecting whether the first or second circuits is open or closed, such that when either of the first or second circuits is closed, the electronic control allows flow of fluid in the first direction only through the at least one external conduit or at least one internal conduit to which the detected circuit is connected.
